(19) United States
(12) Patent Application Publication
(10) Pub. No.: US 2015/0053596 A1
(43) Pub. Date: Feb. 26, 2015

(54) DESALINATION SYSTEM

(71) Applicant: Hitachi, Ltd., Tokyo (JP)

(72) Inventors: Kouji KAGEYAMA, Tokyo (JP); Yoshinobu MIYAKE, Tokyo (JP); Yukinori KATAGIRI, Tokyo (JP); Yukiko ICHIGE, Tokyo (JP); Shigeo HATAMIYA, Tokyo (JP)

(73) Assignee: Hitachi, Ltd.

(21) Appl. No.: 14/448,197

(22) Filed: Jul. 31, 2014

(30) Foreign Application Priority Data
Aug. 26, 2013 (JP) 2013-174209

(51) Int. Cl. C02F 1/00; C02F 1/44

(52) U.S. Cl. CPC C02F 1/008; C02F 1/44; C02F 2103/08
USPC 210/104

(57) ABSTRACT

There is provided a desalination system capable of monitoring a situation of a semipermeable membrane element in real time.

A desalination system 15 includes a plurality of semipermeable membrane elements 10 accommodated in series in a pressure vessel 12, a first intake port 22 for intake of filtrate water from an upstream semipermeable membrane element 10 in the pressure vessel 12, a second intake port 26 for intake of filtrate water from a downstream semipermeable membrane element 10 in the pressure vessel 12, and a supervisory controller 18 that outputs an index correlated with fouling on the semipermeable membrane element 10 based on at least one of first water quantity 46, first water quality 48, second water quantity 52, and second water quality 54, the first water quantity 46 and first water quality 48 being quantity and quality of the filtrate water from the first intake port 22, and the second water quantity 52 and second water quality 54 being quantity and quality of the filtrate water from the second intake port 26.

### CLAIM OF PRIORITY

The present application claims priority from Japanese Patent application serial No. 2013-174209, filed on Aug. 26, 2013, the contents of which are hereby incorporated by reference into this application.

### FIELD OF THE INVENTION

The present invention relates to a desalination system that takes and desalts seawater or saltwater, and particularly relates to a desalination system having a monitoring function.

### BACKGROUND OF THE INVENTION

A water treatment system including a separation membrane is of current interest. Examples of such a water treatment system include a seawater desalination plant and a saltwater desalination plant that each perform filtration treatment using a semipermeable membrane. The semipermeable membrane includes a reverse osmosis membrane and a forward osmosis membrane that are different in structure and in usage. Such a semipermeable membrane is made of a material such as cellulose or polyamide. For example, in the case where seawater is desalted using a reverse osmosis membrane, a pressure equal to or higher than the osmotic pressure of the seawater is applied to the seawater, so that water other than salt in the seawater is exclusively vitrified, and flesh water is allowed be produced.

However, gel bio-fouling may be formed and accumulated on the separation membrane mainly due to organic matters or microorganisms contained in treated seawater, etc. Such bio-fouling degrades permeable performance of the separation membrane, and resultantly causes problems such as an increase in pump power and a decrease in flow rate of resultant filtrate water.

If fouling increases, chemical washing is performed to remove the fouling. When a small amount of fouling is accumulated, the chemical penetrates up to a region near a surface of the semipermeable membrane; hence, the fouling can be easily removed by the chemical. However, when a large amount of fouling is accumulated, the fouling blocks penetration of the chemical. As a result, the chemical may not reach the region near the surface of the semipermeable membrane, and is therefore less likely to remove the fouling. Hence, a technique of early detecting formation of fouling is necessary.

With such a technique, there is known a technique according to International Publication WO 2008/038575 A1. The International Publication WO 2008/038575 A1 describes an operation method of a reverse-osmosis-membrane filtration plant, the method being characterized in that a biofilm formation substrate is placed under a condition that reverse-osmosis-membrane feed water and/or reverse-osmosis-membrane unfiltered water in a reverse-osmosis-membrane filtration section is allowed to flow at a linear velocity similar to a linear velocity of unfiltered water in a reverse osmosis membrane module of the reverse-osmosis-membrane filtration section, and the amount of a biofilm on the biofilm formation substrate is determined at a frequency of once per day to once per six months, and the plant operation method is controlled based on results of such determination.

In the technique according to the International Publication WO 2008/038575 A1, the amount of the biofilm on the surface of the reverse osmosis membrane of the reverse-osmosis-membrane filtration section of the reverse-osmosis-membrane filtration plant can be quantitatively monitored; hence, an operation method of the reverse-osmosis-membrane filtration plant, including a disinfecting method, an chemical washing condition of the reverse osmosis membrane, and an operation condition of a pretreatment section, can be appropriately corrected to avoid an increase in pressure drop or reduction in quantity of permeable water.

In the technique according to the International Publication WO 2008/038575 A1, however, the amount of the biofilm on the biofilm formation substrate is determined based on adenosine triphosphate (ATP) at a frequency of once per day to once per six months; hence, the amount of the biofilm cannot be continuously and automatically measured. As a result, occurrence of fouling may not be detected in the initial stage.

The present invention provides a desalination system capable of monitoring a situation of the semipermeable membrane element in real time.

### SUMMARY OF THE INVENTION

To solve the above-described problems, a desalination system of the present invention is characterized by including a plurality of semipermeable membrane elements accommodated in series in a pressure vessel, a first intake port for intake of filtrate water from an upstream semipermeable membrane element in the pressure vessel, a second intake port for intake of filtrate water from a downstream semipermeable membrane element in the pressure vessel, and a supervisory controller that outputs an index correlated with fouling on the semipermeable membrane element based on at least one of first water quantity, first water quality, second water quantity, and second water quality, the first water quantity and the first water quality being quantity and quality of the filtrate water from the first intake port, and the second water quantity and the second water quality being quantity and quality of the filtrate water from the second intake port.

Another desalination system of the present invention is characterized in that a semipermeable membrane element is accommodated in a pressure vessel, and a filtrate water pipe for catchment of the filtrate water is provided in the semipermeable membrane element, a filtrate-water separation section is provided in the filtrate water pipe, and filtrate water on an upstream side of the filtrate-water separation section and filtrate water on a downstream side of the filtrate-water separation section are separately taken, and a supervisory controller is provided, the supervisory controller outputting an index correlated with fouling on the semipermeable membrane element based on at least one of first water quantity, first water quality, second water quantity, and second water quality, the first water quantity and the first water quality being quantity and quality of the upstream filtrate water, and the second water quantity and the second water quality being quantity and quality of the downstream filtrate water.

According to the invention, a desalination system, which is capable of monitoring a situation of a semipermeable membrane element in real time, is allowed to be provided.

For example, measurement can be performed under the same condition of fouling accumulation in a semipermeable membrane element within a pressure vessel, and consequently more accurate supervisory control can be achieved.

Other issues, configurations, and effects are clarified by the description of the following embodiments.

### BRIEF DESCRIPTION OF THE DRAWINGS

FIG. 1 is a configuration diagram of a major part including a supervisory control section of a desalination system according to Embodiment 1 of the present invention;

FIG. 2 is an overall configuration diagram of a desalination system according to one embodiment of the invention;

FIG. 3 is a configuration diagram of the major part in the case where a filtrate-water separation section is provided in a semipermeable membrane element accommodated in a pressure vessel in Embodiment 1;

FIG. 4 includes explanatory diagrams illustrating a relationship between upstream filtrate-water-quantity information and elapsed days, and between downstream filtrate-water-quantity information and elapsed days;

FIG. 5 includes explanatory diagrams illustrating a ratio of quantity of upstream filtrate water to quantity of downstream filtrate water when the ratio is used as an index;

FIG. 6 is a configuration diagram of a major part including a supervisory control section of a desalination system according to Embodiment 2 of the present invention;

FIG. 7 is a configuration diagram of a major part including a supervisory control section of a desalination system according to Embodiment 3 of the present invention;

FIG. 8 is a diagram explaining a correlation of cost to accumulated amount of fouling during chemical washing;

FIG. 9 is a configuration diagram of a major part including a supervisory control section of a desalination system according to Embodiment 4 of the present invention;

FIG. 10 is a configuration diagram of a major part including a supervisory control section of a desalination system according to Embodiment 5 of the present invention; and

FIG. 11 is a configuration diagram of a major part including a supervisory control section of a desalination system according to Embodiment 6 of the present invention.

### DETAILED DESCRIPTION OF THE PREFERRED EMBODIMENTS

Hereinafter, an embodiment of the present invention is described with drawings. FIG. 2 is an overall configuration diagram of a desalination system according to one embodiment of the invention. In FIG. 2, each solid-line arrow indicates water flow, and each dotted-line arrow indicates a signal line. The desalination system 15 of the invention is configured of, in order in a downstream direction from intake of water to be treated (raw water), a raw water reservoir 1 that reserves taken raw water, a microfiltration (MF) membrane 2, an ultrafiltration (UF) membrane 3, an intermediate tank 9, a pressure vessel 12 accommodating semipermeable membrane elements 10 (described in detail later), an energy recovery device 8, a flesh water reservoir 11, and a concentrated water reservoir 13.

The raw water reservoir 1 reserves seawater or saltwater as raw water to be taken. A coagulant is appropriately injected into the raw water reservoir 1 from a coagulant tank 4 that reserves a polymeric coagulant or an inorganic coagulant via a coagulant injection pump 5. In the raw water reservoir 1, impurities such as organics contained in the raw water are captured by the injected coagulant, and are formed into floc. With the raw water containing the floc, the floc and the impurities contained in the raw water are membrane-separated by a pump with the microfiltration membrane 2 and the ultrafiltration membrane 3 in accordance with pore size of each membrane. After such membrane separation, the raw water (water to be treated) is temporarily stored in the intermediate tank 9. A part of the system corresponding to coagulant injection to membrane separation with the ultrafiltration membrane 3 configures a pretreatment section. The saltwater refers to water containing salt such as sodium chloride, and includes blackish water that exists at a boundary with seawater. The saltwater also exists in fossil water produced through confinement of seawater in the past, and in land water such as water containing salt in a rock salt zone. Examples of the polymeric coagulant include a polyacrylamide coagulant. Examples of the inorganic coagulant include ferric chloride. The pretreatment section may have a mechanism for injecting a pH adjuster as not shown in FIG. 2.

The raw water (water to be treated) stored in the intermediate tank 9 is fed as feed water 14 to the pressure vessel 12 by a pressure pump 16. The feed water 14 is membrane-separated into concentrated water 80 as concentrated brine and filtrate water (flesh water) by the semipermeable membrane elements 10 in the pressure vessel 12. The filtrate water is fed as upstream filtrate water 20 to the flesh water reservoir 11 from one end of the pressure vessel 12, and is fed as downstream filtrate water 24 to the flesh water reservoir 11 from the other end of the pressure vessel 12. The concentrated water 80 is fed to the concentrated water reservoir 13 via the energy recovery device 8. The energy recovered by the energy recovery device 8 is used as a drive source of the pressure pump 16. Each semipermeable membrane element 10 accommodated in the pressure vessel 12 is washed at a desired time by awash supplied from a wash reservoir 6 via a wash injection pump 7.

The supervisory controller 18 monitors a state of the pressure vessel 12 accommodating the semipermeable membrane elements 10, and controls the coagulant injection pump 5, the wash injection pump 7, and the pressure pump 16.

The configuration of the pretreatment section is not limited to the above-described configuration. For example, a sand filtration section may be used in place of the microfiltration membrane 2. Alternatively, the configuration may include only one of the microfiltration membrane 2 and the ultrafiltration membrane 3.

While the semipermeable membrane element 10 includes a forward osmosis (FO) membrane and a reverse osmosis (RO) membrane, description is made below with a case where the reverse osmosis membrane (RO membrane) is used for desalination treatment of seawater or saltwater as raw water.

Throughout the specification, fouling refers to one of variations of membrane performance with the lapse of operation time, i.e., refers to degradation in membrane performance that is caused by an external factor rather than deterioration of the membrane itself, but may be recovered by washing depending on the cause. The fouling includes bio-fouling and scaling. The bio-fouling refers to a biofilm formed on a membrane surface due to an effect of a microorganism or a secretion, causing degradation in membrane performance. The scaling refers to an insoluble substance precipitated on a membrane surface through concentration of the substance to more than the solubility limit. Examples of the insoluble substance precipitated on the membrane surface include calcium carbonate, calcium sulfonate, barium sulfonate, silica, and the like.

With some Embodiments of the present invention, a configuration of a major part including a supervisory control section of the desalination system, i.e., a specific configuration including the pressure pump 16, the pressure vessel 12, and the supervisory controller 18 is now described with drawings.

### Embodiment 1

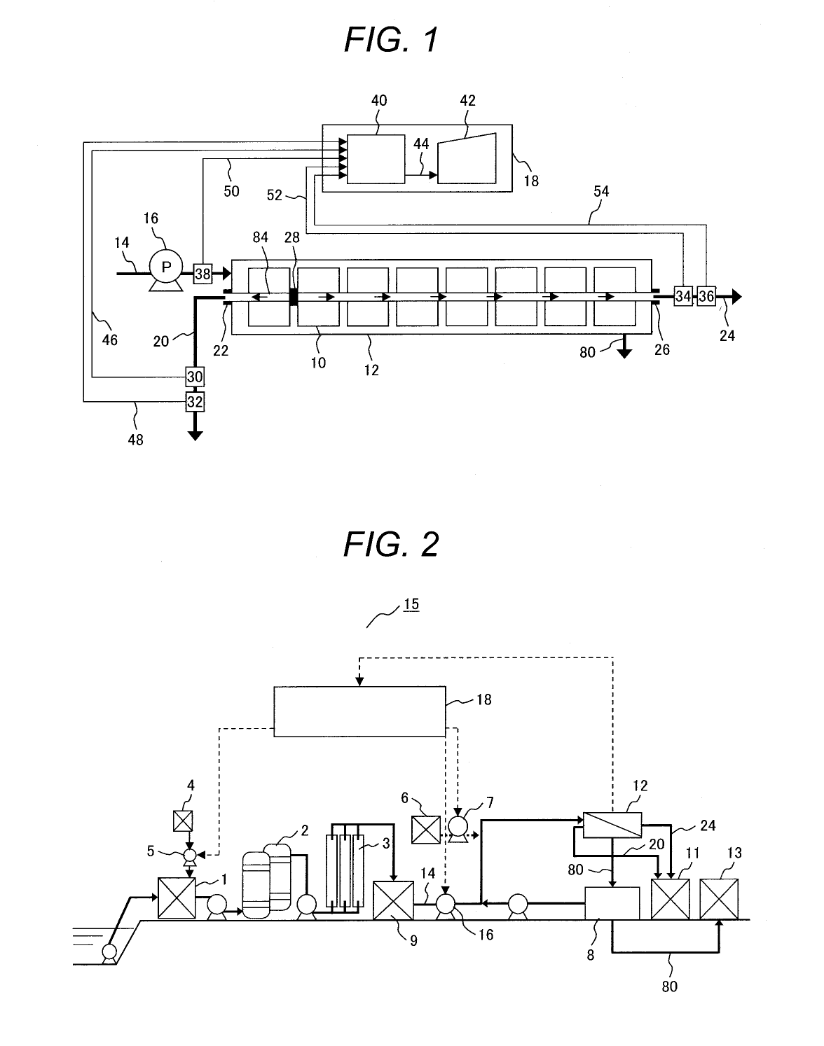

FIG. 1 is a configuration diagram of a major part including a supervisory control section of a desalination system according to Embodiment 1 of the present invention. In FIG. 1, the same components as those in FIG. 2 are designated by the same numerals. Desalination is achieved by feeding the feed water 14, by the pressure pump 16, to a primary side of the semipermeable membrane elements (RO membrane elements) 10 accommodated in the pressure vessel 12, and membrane-separating the feed water 14 into filtrate water (flesh water) and the concentrated water 80 being concentrated brine. Primary pressure of the semipermeable membranes must be maintained in the pressure vessel 12; hence, the concentrated water 80 is returned to normal pressure via a valve or the energy recovery device 8.

As illustrated in FIG. 1, the pressure vessel 12 accommodates eight semipermeable membrane elements 10 in series therein, through the centers of which a filtrate water pipe 84 communicates from an upstream side to a downstream side. In addition, the pressure vessel 12 is configured such that the filtrate water from the semipermeable membrane element 10 is catchable into the filtrate water pipe 84 via a plurality of water catchment holes provided in the periphery of the filtrate water pipe 84. A filtrate-water separation section 28 is provided in a portion of the filtrate water pipe 84 between a first stage (a first semipermeable membrane element 10) and a second stage (a second semipermeable membrane element 10) on an inflow side of the feed water 14 of the semipermeable membrane elements 10 arranged in series. The pressure vessel 12 has an upstream filtrate-water intake port 22 at its first end as an upstream end into which the feed water 14 flows, and a downstream filtrate-water intake port 26 at its second end as a downstream end opposite the upstream filtrate-water intake port 22.

The feed water 14 is pressurized into high-pressure water by the pressure pump 16 and flows into the pressure vessel 12. Filtrate water from the first-stage semipermeable membrane element 10 is caught by the filtrate water pipe 84, and flows toward the second-stage semipermeable membrane element 10 (on a downstream side) within the filtrate water pipe 84. At this time, flow of the filtrate water to the downstream side of the filtrate water pipe 84 is blocked by the filtrate-water separation section 28. The filtrate water thus flows out from the upstream filtrate-water intake port 22. The filtrate water from the semipermeable membrane elements 10 in the second and subsequent stages, i.e., in the second to eighth stages, is caught by the filtrate water pipe 84 and sequentially flows to the downstream side, and eventually flows out from the downstream filtrate-water intake port 26. Consequently, the filtrate water from the first-stage semipermeable membrane element 10 is hydraulically separated from the filtrate water from the semipermeable membrane elements 10 in the second and subsequent stages within the filtrate water pipe 84. Thus, the filtrate-water separation section 28 serves as a divider, and is actually configured of, for example, a sealing plug or a member having a shutter mechanism.

The major part illustrated in FIG. 1 further includes a feed-water pressure measuring section 38 that measures pressure of the feed water 14 pressurized into high-pressure water by the pressure pump 16 before flowing into the pressure vessel 12, an upstream filtrate-water-quantity measuring section 30 that measures flow rate of the upstream filtrate water 20 flowing from the upstream filtrate-water intake port to the flesh water reservoir 11, and an upstream filtrate-water-quality measuring section 32 that measures quality of the upstream filtrate water 20. The major part further includes a downstream filtrate-water-quantity measuring section 34 that measures flow rate of the downstream filtrate water 24 flowing from the downstream filtrate-water intake port 26 to the flesh water reservoir 11, and a downstream filtrate-water-quality measuring section 36 that measures quality of the downstream filtrate water 24. The item of quality of the filtrate water measured by the upstream filtrate-water-quality measuring section 32 and the downstream filtrate-water-quality measuring section 36 includes one of temperature, conductivity, and pH, or a combination thereof. The item of the water quality is not limited thereto, and may appropriately include other items indicating quality of the filtrate water.

Feed-water pressure measurement information 50 is produced through measurement by the feed-water pressure measuring section 38, and is sent to an index calculation section 40 as a part of the supervisory controller 18. Upstream filtrate-water-quantity information 46 produced through measurement by the upstream filtrate-water-quantity measuring section 30, upstream filtrate-water-quality information 48 produced through measurement by the upstream filtrate-water-quality measuring section 32, downstream filtrate-water-quantity information 52 produced through measurement by the downstream filtrate-water-quantity measuring section 34, and downstream filtrate-water-quality information 54 produced through measurement by the downstream filtrate-water-quality measuring section 36 are also sent to the index calculation section 40.

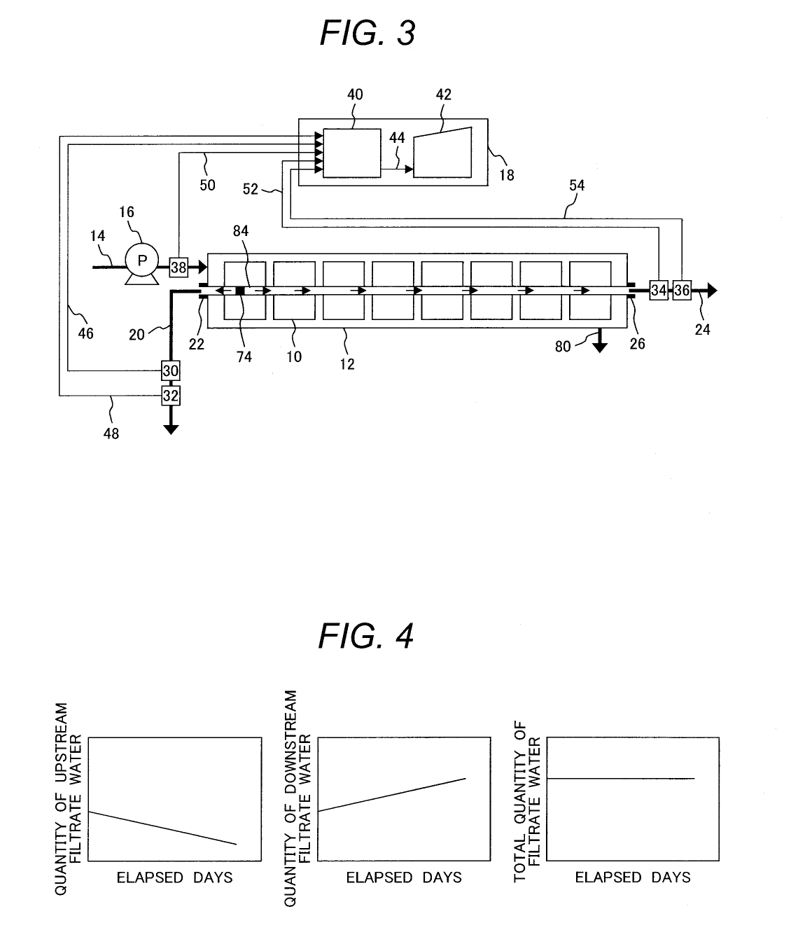

A modification of the disposed position of the above-described filtrate-water separation section 28 is now described. FIG. 3 is a configuration diagram of the major part in the case where the filtrate-water separation section is provided in the semipermeable membrane element accommodated in the pressure vessel in Embodiment 1. Description with FIG. 1 has been made on a case where the filtrate-water separation section 28 is disposed in the portion of the filtrate water pipe 84 between the first-stage semipermeable membrane element 10 and the second-stage semipermeable membrane element 10 accommodated in the pressure vessel 12. In FIG. 3, the filtrate-water separation section 28 is provided in a portion of the filtrate water pipe 84 within the first-stage semipermeable membrane element 10 in the pressure vessel 12. In this case, a plug 74 is used as the filtrate-water separation section 28. The plug 74 desirably has a spherical shape so as to be easily installed though it may have a cylindrical shape. The material of the plug 74 is preferably an elastic material that appropriately includes resins (such as rubber), but may also include a fibrous substance as long as the substance can hydraulically separate the filtrate water within the filtrate water pipe 84. Consequently, filtrate water, which is caught from part of the upstream water catchment holes into the filtrate water pipe 84, can be separated within one semipermeable membrane element 10, and therefore the semipermeable membrane element 10 can be more accurately monitored. Although FIG. 3 shows a configuration where the semipermeable membrane elements 10 in second to eighth stages are arranged in series on the downstream side of the first-stage semipermeable membrane element 10, this is not limitative. In another usable configuration, one semipermeable membrane element 10 is accommodated in the pressure vessel 12.

Return to FIG. 1, an index-value calculation section 40 calculates index value information 44 using all or part of the received pieces of information including the upstream filtrate-water-quantity information 46, the upstream filtrate-water-quality information 48, the downstream filtrate-water-quantity information 52, the downstream filtrate-water-quality information 54, and feed-water pressure information 50. To calculate the index value information 44, it is desirable to use water temperature information of one of the feed water 14, the concentrated water 80, and the upstream filtrate water 20 or the downstream filtrate water 24. The calculated index value information 44 is sent to a display unit 42 as a part of the supervisory controller 18. An operator can recognize a state of bio-fouling on the semipermeable membrane element 10 within the pressure vessel 12 in a temporally continuous manner through the display unit 42.

For example, the index-value calculation section 40 is configured of a processor such as CPU and a storage device including RAM and ROM, where the CPU reads out various programs stored in the ROM, executes processing on data stored in the RAM, and stores the processed data into the RAM. Calculation of the index value information 44 by the index-value calculation section 40 is now described below.

First, in the simplest case, the index-value calculation section 40 defines the upstream filtrate-water-quantity information 46 as the index value information 44. FIG. 4 includes explanatory diagrams illustrating a relationship between upstream filtrate-water-quantity information and elapsed days, and between downstream filtrate-water-quantity information and elapsed days. When bio-fouling increases in the upstream semipermeable membrane element 10 after certain days have elapsed from operation start of the desalination system 15, the quantity of the upstream filtrate water 20 decreases. In the typical desalination system 15, however, quantitative operation is performed so that the total quantity of filtrate water is constant; hence, such a decrease in upstream filtrate water 20 is absorbed into an increase in downstream filtrate water 24. Hence, instead of estimating the accumulated amount of bio-fouling from the feed-water pressure and/or the total quantity of filtrate water over the entire pressure vessel 12, the upstream filtrate-water-quantity information 46 is directly displayed as a temporal variation by the display unit 42, and the accumulated amount of bio-fouling can be determined from an absolute value of the information 46, and increase rate of the bio-fouling can be determined from a gradient thereof. When the temporal variation of the quantity of the upstream filtrate water is thus used as an index (index 1), the feed-water pressure information 50, the upstream filtrate-water-quality information 48, the downstream filtrate-water-quantity information 52, and the downstream filtrate-water-quality information 54 are not necessary. In this case, therefore, a measuring section adequately includes only the upstream filtrate-water-quantity measuring section 30.

Conversely, the downstream filtrate-water-quantity information 52 conversely related to the upstream filtrate-water-quantity information 46 is directly displayed as a temporal variation by the display unit 42, and the accumulated amount of bio-fouling in the upstream semipermeable membrane element 10 can be determined from an absolute value of the information 52, and increase rate of the bio-fouling can be determined from a gradient thereof. In this case, as with the above-described case, the measuring section adequately includes only the downstream filtrate-water-quantity measuring section 34.

The feed water 14 is separated into the upstream filtrate water 20, the downstream filtrate water 24, and the concentrated water 80 by the pressure vessel 12 accommodating the semipermeable membrane elements 10, where the filtrate water accounts for 10% of the feed water 14, and the concentrated water 80 accounts for 90% thereof. As a result, formation of bio-fouling on the surface of the semipermeable membrane element 10 can be immediately detected through measurement of the temporal variation of the upstream filtrate water 20 or the downstream filtrate water 24.

Actually, values of temperature or salt concentration of seawater are in general temporally varied. Since such values affect quantity of filtrate water, the water quantity is preferably used while influence of the values is compensated in order to more accurately determine the accumulated amount of bio-fouling. An exemplary procedure for compensating the influence of water temperature and salt concentration is described below.

A cake resistance (filtration resistance) of the semipermeable membrane element 10 at a certain time is denoted as Rc. The seawater temperature measured by the upstream filtrate-water-quality measuring section 32 is denoted as Temp [° C.]. The feed pressure of the feed water 14 to the pressure vessel 12 measured by the feed-water pressure measuring section 38 is denoted as P [MPa]. The flow rate of the filtrate water measured by the upstream filtrate-water-quantity measuring section 30 is denoted as Qp [m³/s]. The osmotic pressure of seawater is denoted as π [MPa]. The membrane area of the semipermeable membrane element 10 is denoted as A [m²]. The pure-water permeation coefficient is denoted as Lv₀ [m (Pa·s)⁻¹]. First, filtration flux Jv [m/s] in the semipermeable membrane element 10 is obtained by Formula (1).

Jv=Qp/A (1)

When the bio-fouling is accumulated on the surface of the semipermeable membrane element 10, a cake filtration phenomenon often occurs in the semipermeable membrane element 10. In such a case, the cake resistance Rc is calculated by Formula (2) using the filtration flux Jv calculated by Formula (1).

Rc=(1/ρ)×(((P−π)/Jv)−(1/Lv₀)) (2)

where ρ is the coefficient of viscosity [Pa·s] of water. The coefficient of viscosity ρ is in general a function of water temperature, and, for example, can be approximately obtained by Formula (3).

ρ=4.7×10⁻⁷×Temp²−4.6×10⁻⁵×Temp+1.8×10⁻³ (3)

Furthermore, the pure-water permeation coefficient Lv₀ is a function of water temperature, the data of which is given in the name of Temperature Coefficient Factor (TCF) from a membrane manufacturer.

The salt concentration affects the above-described osmotic pressure π [MPa] of seawater. When the salt concentration is denoted as C [mg·L⁻¹], for example, a relationship between the salt concentration C [mg·L⁻¹] and the osmotic pressure π [MPa] is represented by the following Formula.

π=a·C+b (4)

where a and b are each a coefficient.

When ρ and π obtained by Formulas (3) and (4), the value of Lv₀ given from the membrane manufacturer, and Jv obtained by Formula (1) are applied to Formula (2), flow rate Qp of filtrate water can be converted into cake resistance Rc. The cake resistance Rc can be used as an index (index 2) with the influence of water temperature and salt concentration being compensated. Consequently, the accumulated amount of bio-fouling can be more accurately determined.

The index 2 is desirably obtained for the upstream filtrate water 20. In the case of quantitative operation, however, the index 2 may be obtained for the downstream filtrate water 24 conversely related to the upstream filtrate water 20.

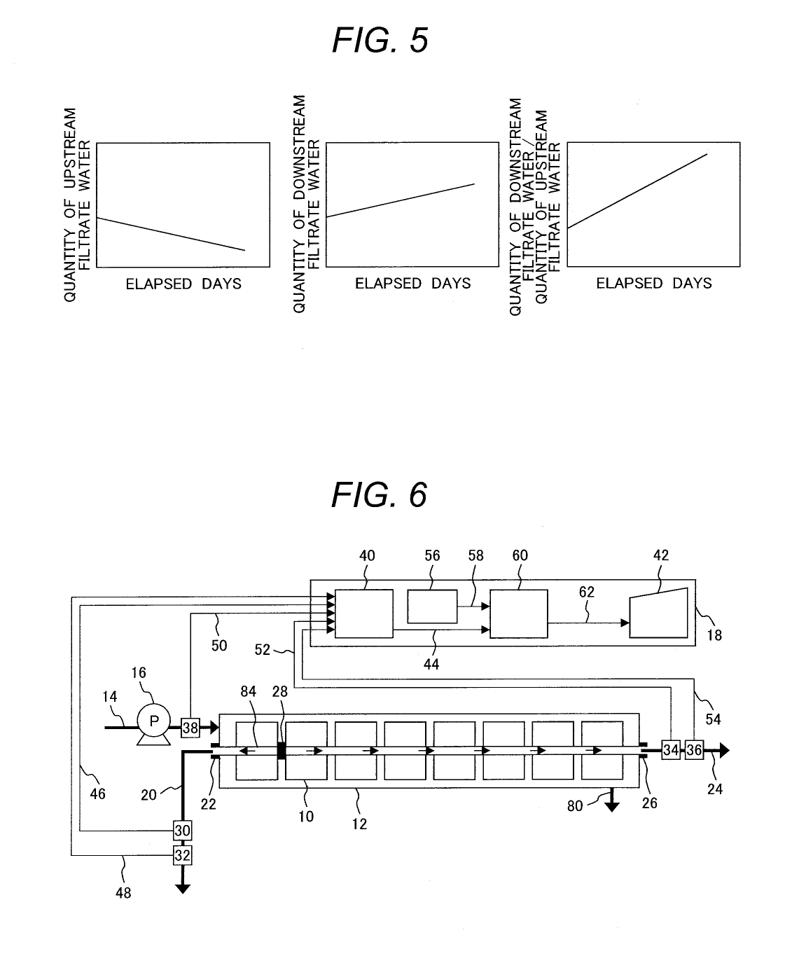

The accumulated amount of bio-fouling may be indicated with another simple index, i.e., a ratio of quantity of upstream filtrate water 20 to quantity of downstream filtrate water 24, or an index using the ratio. As illustrated in FIG. 4, in the case of quantitative operation, the quantity of downstream filtrate water 24 increases by a level corresponding to a decrease in quantity of upstream filtrate water 20. Hence, a large change rate is given by obtaining a ratio between the values of such two types of water quantity rather than using one of the values, and thus determination accuracy is improved. FIG. 5 includes explanatory diagrams illustrating a ratio of quantity of downstream filtrate water to quantity of upstream filtrate water when the ratio is used as an index.

For example, a case of preparing 1.0 of filtrate water in quantitative operation is assumed. The quantity of each of upstream filtrate water 20 and downstream filtrate water 24 is assumed to be 0.5. If the upstream filtrate water 20 is decreased to 0.4 at a certain time, the change rate is 100×(0.5-0.4)/0.5=20%. If “quantity of downstream filtrate water to quantity of upstream filtrate water” is used as the ratio of water quantity, the ratio is increased from 0.5/0.5=1.0 at operation start to 0.6/0.4=1.5 at the certain time, i.e., the change rate is increased to 100×(1.5-1.0)=50%. A difference in water temperature on a primary side between an upstream semipermeable membrane element 10 and a downstream semipermeable membrane element 10 is substantially constant even if temperature of the feed water 14 is varied. In addition, a difference in salt concentration on a primary side between an upstream semipermeable membrane element 10 and a downstream semipermeable membrane element 10 is substantially constant even if salt concentration of the feed water 14 is varied. As a result, when the ratio of the quantity of upstream filtrate water 20 to the quantity of downstream filtrate water 24 is thus used as an index (index 3), the feed-water pressure information 50, the upstream filtrate-water-quality information 48, and the downstream filtrate-water-quality information 54 are not necessary. In this case, therefore, a measuring section adequately includes only the upstream filtrate-water-quantity measuring section 30 and the downstream filtrate-water-quantity measuring section 34.

When bio-fouling is accumulated, dissolved oxygen contained in the feed water 14 is consumed by microorganisms metabolizing within that bio-fouling, and thus concentration of dissolved carbon dioxide increases. Such an increase in concentration of dissolved carbon dioxide results in a decrease in hydrogen-ion exponent pH. The accumulated amount of bio-fouling may also be determined through measurement of the amount of such a decrease in pH. When pH as a type of quality of the upstream filtrate water 20 is used as an index (index 4) in this way, a measuring section adequately includes only the upstream filtrate-water-quality measuring section 32. In this case, through measurement of pH of the upstream filtrate water 20 separated by the filtrate-water separation section 28, the accumulated amount of bio-fouling can also be accurately grasped rather than measuring pH of the total quantity of filtrate water as a mixture of the upstream filtrate water 20 and the downstream filtrate water 24 that contains no bio-fouling and has unreduced pH.

The above-described content is on the assumption that the desalination system 15 has only one pressure vessel 12. However, the actual desalination system 15 typically has a configuration where a plurality of pressure vessels 12 are provided while being connected in parallel or in series to one another in multilevels. In such a case, when a plurality of pressure vessels 12, which include the same semipermeable membrane elements 10 and are operated under the same condition, are provided, and if the measuring section and the filtrate-water separation section 28 as illustrated in FIG. 1 are provided in only one or some pressure vessels 12, a situation of bio-fouling in each pressure vessel 12, in which the measuring section and the filtrate-water separation section 28 are not provided, can be estimated.

In this case, a situation of bio-fouling in the pressure vessel 12, in which the measuring section and the filtrate-water separation section 28 as illustrated are provided, must be equal to a situation of bio-fouling in the pressure vessel 12, in which those are not provided. Although flow of the high-pressure feed water 14 to the semipermeable membrane element 10 is equal between such pressure vessels 12, the flow is different between them after the feed water 14 enters the filtrate water pipe 84. After the upstream filtrate water 20 is subjected to measurement of quantity and quality thereof, the water 20 is desirably allowed to join the downstream filtrate water 24 in a closed-pipe manner in order to achieve the same filtration condition between the semipermeable membrane elements 10. This makes it possible to easily maintain the same filtration situation as that in the pressure vessel 12 in which the measuring section and the filtrate-water separation section 28 are not provided.

Some desalination system 15 may be configured such that only the first-stage (first) semipermeable membrane element 10 illustrated in FIG. 3 is accommodated in a first pressure vessel 12, a plurality of semipermeable membrane elements 10 in the second and subsequent stages (second and later semipermeable membrane elements 10) are accommodated in a second pressure vessel 12 while being arranged in series, and such pressure vessels 12 are connected to each other with a valve therebetween. In such a case, the plug 74 illustrated in FIG. 3 is provided in the filtrate water pipe 84 provided in the first pressure vessel 12, and the upstream filtrate-water-quantity information 46 or the upstream filtrate-water-quality information 48 for that pressure vessel 12 is used, thereby the accumulated amount of bio-fouling can be determined more accurately.

### Embodiment 2

FIG. 6 is a configuration diagram of a major part including a supervisory control section of a desalination system according to Embodiment 2 of the present invention. The same components as those in Embodiment 1 are designated by the same numerals. Embodiment 2 is different from Embodiment 1 in that a threshold input section 56 and a state determination/calculation section 60 are provided in the supervisory controller 18.

The upstream filtrate water 20 is separated from the downstream filtrate water 24 by the filtrate-water separation section 28. Pieces of information on quantity and quality of such filtrate water, i.e., the upstream filtrate-water-quantity information 46, the upstream filtrate-water-quality information 48, the downstream filtrate-water-quantity information 52, the downstream filtrate-water-quality information 54, and the feed-water pressure information 50 are provided to the index-value calculation section 40 as with Embodiment 1.

The index value information 44 output from the index-value calculation section 40 is compared by the state determination/calculation section 60 to a threshold 58 that is beforehand set via the threshold input section 56. When the index value information 44 exceeds the threshold 58, the state determination/calculation section 60 outputs alarm information 62 to the display unit 42. Through display of the alarm information 62 by the display unit 42, an operator can recognize a situation being at a level of alarming.

As with the index calculation section 40, the state determination/calculation section 60 is configured of, for example, a processor such as CPU and a storage device including RAM and ROM, where the CPU reads various programs stored in the ROM, executes processing on data stored in the RAM, and stores the processed data into the RAM. Operation of the state determination/calculation section 60 is now described.

In one case where the state determination/calculation section 60 outputs the alarm information 62, the accumulated amount of bio-fouling increases on a surface of the semipermeable membrane element 10 accommodated in the pressure vessel 12, and chemical washing operation should be performed early. This is because an excessive increase in accumulated amount of bio-fouling suppresses the effect of chemical washing. Specifically, when the quantity of the upstream filtrate water 20 as shown in FIG. 4 is lower than the beforehand set threshold 58, the state determination/calculation section 60 outputs the alarm information 62. In another usable configuration, when the quantity of the downstream filtrate water 24 conversely related to the upstream filtrate water 20 exceeds the threshold 58, the state determination/calculation section 60 outputs the alarm information 62.

In another usable configuration, when the index 2 described in Embodiment 1, i.e., the cake resistance Rc is used, and when a value of the cake resistance Rc exceeds the beforehand set threshold 58, the state determination/calculation section 60 outputs the alarm information 62.

In another usable configuration, when the index 3 described in Embodiment 1, i.e., the ratio of quantity of the downstream filtrate water 24 to quantity of the upstream filtrate water 20 is higher than or lower than the beforehand set threshold 58, the state determination/calculation section 60 outputs the alarm information 62. Specifically, a case where “quantity of the downstream filtrate water 24/quantity of the upstream filtrate water 20” exceeds the threshold 58 shows an increase in bio-fouling formed on a surface of the semipermeable membrane element 10. A case where “quantity of the downstream filtrate water 24/quantity of the upstream filtrate water 20” is lower than the threshold 58 shows an increase in scaling formed on a surface of the semipermeable membrane element 10. This is based on a fact that bio-fouling is easily formed on the upstream side of the semipermeable membrane element 10, and scaling is easily formed on the downstream side thereof.

In another case where the state determination/calculation section 60 outputs the alarm information 62, when a component that causes bio-fouling contained in the feed water 14 drastically increases, change in operation amount of the pretreatment section or stop of water-intake may be required. In such a case, temporal variation of the accumulated amount of bio-fouling is essential, and the threshold 58 that is beforehand set by the threshold input section 56 is a value on the temporal variation. Specifically, when temporal variation of the quantity of the upstream filtrate water 20 illustrated in FIG. 4 is lower than the beforehand set threshold 58, the state determination/calculation section 60 outputs the alarm information 62. In another usable configuration, when temporal variation of the quantity of the downstream filtrate water 24 conversely related to the upstream filtrate water 20 exceeds the beforehand set threshold 58, the state determination/calculation section 60 outputs the alarm information 62. In still another usable configuration, when a difference in gradient of temporal variation of the quantity of the upstream filtrate water 20 between previous and current states exceeds the threshold 58, the state determination/calculation section 60 outputs the alarm information 62. Consequently, gradient of temporal variation of the quantity of the upstream filtrate water 20, i.e., change rate of the water quantity is monitored, which allows early detection of presage of an increase in bio-fouling in a stage before the temporal variation of the water quantity reaches the threshold. If the gradient of temporal variation of the water quantity drastically increases, for example, there is considered a possibility that previous organic fouling suddenly starts to change into bio-fouling. In such a case, probably, it is preferred that the system is stopped, or washing is performed in accordance with the alarm information 62.

In the case of using the index 2, when temporal variation of the above-described cake resistance Rc exceeds the beforehand set threshold 58, the state determination/calculation section 60 may output the alarm information 62. Alternatively, in the case of using the index 3, when temporal variation of the ratio of the quantity of the upstream filtrate water 20 to the quantity of the downstream filtrate water 24 is higher than or lower than the beforehand set threshold 58, the state determination/calculation section 60 may output the alarm information 62.

### Embodiment 3

FIG. 7 is a configuration diagram of a major part including a supervisory control section of a desalination system according to Embodiment 3 of the present invention. The same components as those in Embodiment 1 are designated by the same numerals. Embodiment 3 is different from Embodiment 1 in that a recommended-value calculation section 64 is provided in the supervisory controller 18.

As with Embodiment 1, the upstream filtrate water 20 is separated from the downstream filtrate water 24 by the filtrate-water separation section 28. Pieces of information on quantity and quality of such filtrate water, i.e., the upstream filtrate-water-quantity information 46, the upstream filtrate-water-quality information 48, the downstream filtrate-water-quantity information 52, the downstream filtrate-water-quality information 54, and the feed-water pressure information 50 are provided to the index-value calculation section 40.

The recommended-value calculation section 64 calculates a recommended value of chemical washing time or flushing time of the semipermeable membrane element 10, or a recommended value of operation amount of the pretreatment section based on the index value information 44 received from the index-value calculation section 40, and sends the recommended value as recommended-value information 66 to the display unit 42.

The flushing refers to removal of extraneous matters on the surface of the semipermeable membrane element 10 by increasing velocity of the feed water 14 flowing through the semipermeable membrane element 10. For example, while pressure of the feed water is fixed, opening of each of undepicted valves is increased, the valves being placed in the filtrate water pipe 84 provided in the pressure vessel 12 in which a plurality of semipermeable membrane elements 10 are arranged in series, and placed in a flow-out pipe of the concentrated water 80, so that internal pressure of each pipe is decreased. Thus, velocity of the feed water 14 is increased. In the chemical washing, a wash is supplied to the pressure vessel 12 via the wash injection pump 7, and is allowed to stay for a predetermined time between an inner wall of the pressure vessel 12 and the semipermeable membrane element 10. Subsequently, the wash is discharged, and each semipermeable membrane element 10 is washed through circulation of the feed water 14.

Operation of the recommended-value calculation section 64 is now described. Chemical washing more effectively reduces the accumulated amount of bio-fouling with an increase in frequency thereof. On the other hand, such higher-frequency chemical washing has demerits of high chemical cost, necessary waste disposal, progress of chemical degradation of the semipermeable membrane element 10 (change in physical properties of a membrane substance due to the wash), a decrease in quantity of filtrate water due to prohibition of filtration during chemical washing. In consideration of these, a function of cost to accumulated amount of bio-fouling during chemical washing is obtained. If the chemical washing is performed at an extremely low level of accumulated amount of bio-fouling, chemical washing-related cost increases due to the above-described demerits. Conversely, if the chemical washing is performed at an extremely high level of accumulated amount of bio-fouling, chemical cost or power cost of the pressure pump 16 increases due to an increase in necessary chemical amount or reduction in recovery rate.

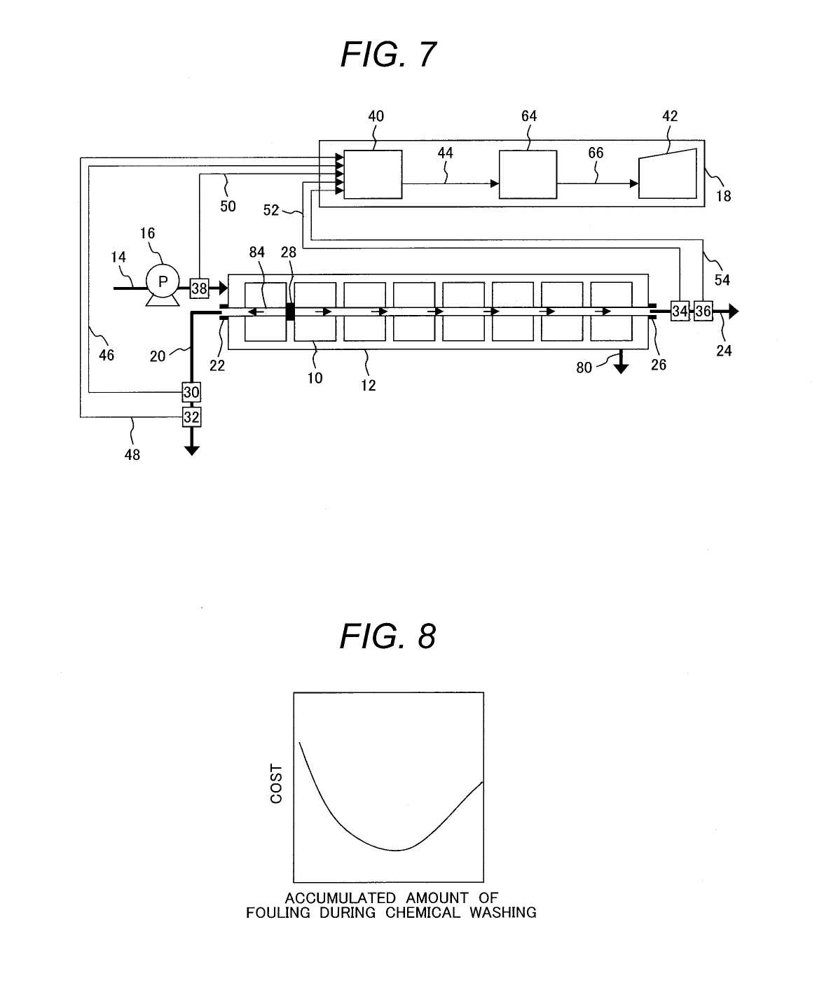

FIG. 8 is a diagram explaining a correlation of cost to accumulated amount of fouling during chemical washing. The relationship of cost to accumulated amount of bio-fouling during chemical washing is represented as a U-shape function as shown in FIG. 8.

Although other influential items exist, the above-described cost is now exemplarily represented by the following formula.

Cost=chemical cost+waste disposal cost+semipermeable membrane element change cost+pressure pump power cost

Although this cost is desirably minimized, the items in the right side are each a function of accumulated amount of fouling, some of which is positively or negatively correlated with the accumulated amount of fouling. An exemplary function in a certain limited range is shown below. Since a value of each coefficient varies depending on a type of the semipermeable membrane element 10 to be used or concentration of the chemical, the value is provisionally represented as one of C1, C2 . . . , and C10 (each being one of positive integers including 0).

Chemical cost=C1−C2·(accumulated amount of fouling during chemical washing) (5)

Waste disposal cost=C3−C4·(accumulated amount of fouling during chemical washing) (6)

Semipermeable membrane element change cost=C5+C6·(accumulated amount of fouling during chemical washing)^{-C7} (7)

Pressure pump power cost=C8+C9·(accumulated amount of fouling during chemical washing)C¹⁰ (8)

When Formulas (5) to (7) and Formula (8) are summed, the correlation of cost to accumulated amount of fouling during chemical washing is represented as the U-shape function as shown in FIG. 8.

The recommended-value calculation section 64 beforehand stores the above-described function. The recommended-value calculation section 64 compares the index value information 44 (one of the above-described indexes 1 to 4), which is obtained based on quantity or quality of one of the upstream filtrate water and the downstream filtrate water, pressure of the feed water 14, or a combination thereof, to the accumulated amount of fouling at the minimum point of the U-shape function illustrated in FIG. 8. When the two have the same value, the recommended-value calculation section 64 sends to the display unit 42 the recommended-value information 66 indicating that the current stage has arrived at a recommendable chemical washing time. Alternatively, the recommended-value calculation section 64 compares temporal variation of the index value information 44 (one of the above-described indexes 1 to 4) to accumulated amount of fouling at the minimum point of the U-shape function as shown in FIG. 8, and therethrough calculates the timing at which the two have the same value, and sends an estimated value of chemical washing time as the recommended-value information 66 to the display unit 42. Examples of the wash include hydrochloric acid, phosphoric acid, citric acid, sodium hydrosulfite, sodium hydroxide, sodium dodecyl sulfate, acetic acid, sodium triphosphate, ethylenediaminetetraacetic acid (EDTA), surfactants, 2-Methyl-4-Isothiazolin-3-one, and 5-Chloro-2-methyl-4-isothiazolin-3-one.

Flushing also more effectively reduces the accumulated amount of bio-fouling with an increase in frequency thereof. On the other hand, such higher-frequency flushing has demerits of a decrease in quantity of filtrate water due to prohibition of filtration during flushing, and wasteful power of the pressure pump 16 and wasteful feed water 14 during flushing. As with the chemical washing, with the flushing, a function of cost to the accumulated amount of bio-fouling is also obtained in a U-shape. When a microbicide, a dispersant (for example, nitrogen monoxide), or an enzyme is added during flushing, cost thereof is also included in the function. Examples of the microbicide include peracetic acid (PAA), 2,2-dibromo-3-nitrilopropionamide (DBNPA), 2-Methyl-4-Isothiazolin-3-one, and 5-Chloro-2-methyl-4-isothiazolin-3-one.

The recommended-value calculation section 64 beforehand stores the above-described function. The recommended-value calculation section 64 compares the index value information 44 (one of the above-described indexes 1 to 4), which is obtained based on quantity or quality of one of the upstream filtrate water and the downstream filtrate water, pressure of the feed water 14, or a combination thereof, to accumulated amount of fouling at the minimum point of the U-shape function on flushing. When the two have the same value, the recommended-value calculation section 64 sends, to the display unit 42, the recommended-value information 66 indicating that the current stage has arrived at a recommendable flushing time. Alternatively, the recommended-value calculation section 64 compares temporal variation of the index value information 44 (one of the above-described indexes 1 to 4) to accumulated amount of fouling at the minimum point of the U-shape function on flushing, and therethrough calculates the timing at which the two have the same value, and sends an estimated value of chemical flushing time as the recommended-value information 66 to the display unit 42.

With control of the pretreatment section, operation factors are different for treatment procedures of individual parts, and control of coagulation treatment is now described. Temporal variation of the index value information 44, which is obtained based on quantity or quality of one of the upstream filtrate water and the downstream filtrate water, pressure of the feed water 14, or a combination thereof, is obtained. As described above, the supervisory controller 18 of the invention can continuously capture measurement data, and therefore can also acquire data of temporal variation of the accumulated amount of bio-fouling in a short period. A coagulant injection ratio is subjected to feedback control such that a value of temporal variation of the accumulated amount of bio-fouling is equal to or lower than a desired value, thereby if the amount of fouling-causing substance contained in the feed water 14 drastically increases, an injection ratio of the coagulant to be injected into the raw water in the raw water reservoir 1 is controlled, so that the fouling-causing substance can be caught by the coagulant, and thus accumulation of bio-fouling can be suppressed. In Embodiment 3, the coagulant injection ratio is sent to the display unit 42 as the recommended-value information 66 of operation amount of the pretreatment section.

Although Embodiment 3 has been exemplarily described with bio-fouling as one of types of fouling, similar operation is allowed to be performed on scaling.

### Embodiment 4

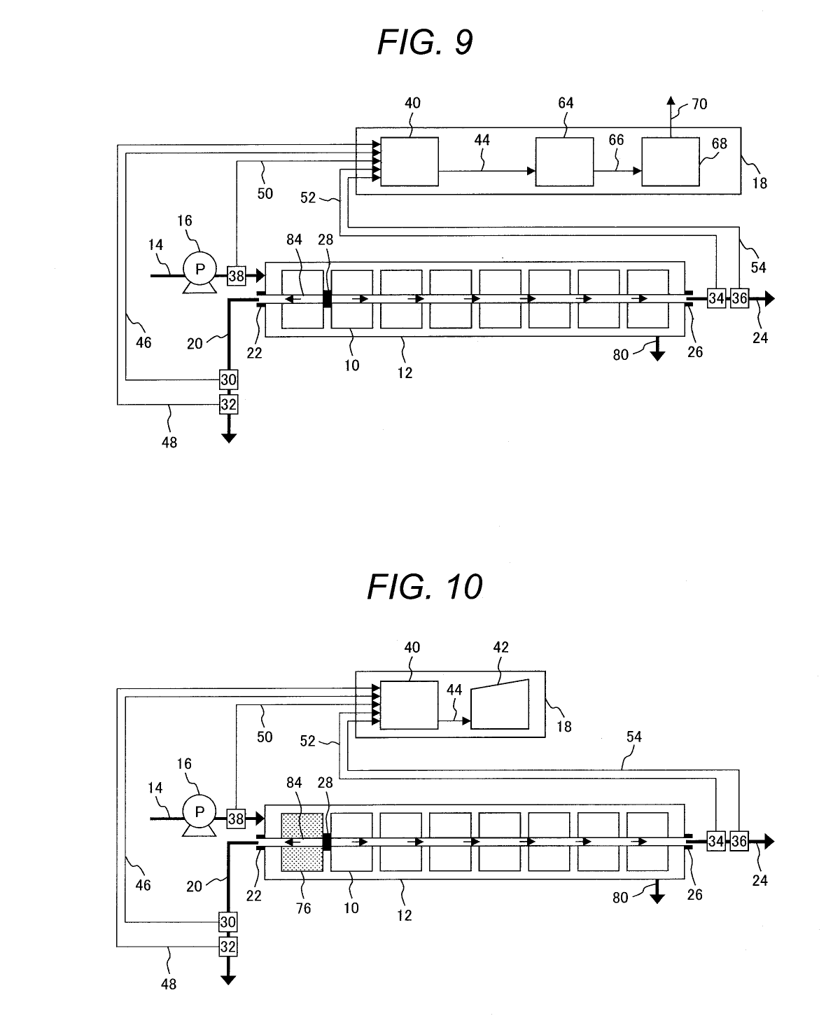

FIG. 9 is a configuration diagram of a major part including a supervisory control section of a desalination system according to Embodiment 4 of the present invention. The same components as those in Embodiments 1 and 3 are designated by the same numerals. Although Embodiment 3 is in a configuration where the recommended-value information 66 obtained by the recommended-value calculation section 64 is sent to the display unit 42, Embodiment 4 is different from Embodiment 3 in that the supervisory controller 18 is provided with a control execution section 68 that outputs a control instruction 70 of operation amount of the pretreatment section, etc. based on the recommended-value information 66.

As with Embodiment 1, the upstream filtrate water 20 is separated from the downstream filtrate water 24 by the filtrate-water separation section 28. Pieces of information on quantity and quality of such filtrate water, i.e., the upstream filtrate-water-quantity information 46, the upstream filtrate-water-quality information 48, the downstream filtrate-water-quantity information 52, the downstream filtrate-water-quality information 54, and the feed-water pressure information 50 are provided to the index-value calculation section 40.

As with Embodiment 3, the recommended-value calculation section 64 obtains the recommended-value information 66 based on index value information 44 received from the index-value calculation section 40. In Embodiment 3, the obtained recommended-value information 66 is displayed on a screen of the display unit 42 for operation assist for an operator. On the other hand, Embodiment 4 is characterized in that the recommended-value information 66 is sent to the control execution section 68, and the control execution section 68 outputs operation amount of the pretreatment section, etc. to control the desalination system.

The control execution section 68 receives the recommended-value information 66, which is an estimated value of chemical washing time given by the recommended-value calculation section 64 as described in Embodiment 3, and sends the control instruction 70 to the wash injection pump 7 to inject a predetermined amount of wash from the wash reservoir 6 into the pressure vessel 12.

The control execution section 68 receives the coagulant injection ratio as the recommended-value information 66 of operation amount of the pretreatment section from the recommended-value calculation section 64, and sends the control instruction 70 to the coagulant injection pump 5 to inject an inorganic coagulant or a polymeric coagulant reserved in the coagulant tank 4 into the raw water reservoir 1 in accordance with the received coagulant injection ratio. Consequently, raw water reduced in amount of fouling-causing substance is fed to the intermediate tank 9, and is then fed as the feed water 14 to the pressure vessel 12 by the pressure pump 16. This makes it possible to suppress accumulation of bio-fouling on a surface of the semipermeable membrane element 10 accommodated in the pressure vessel 12.

According to such a configuration, Embodiment 4 enables use of the desalination system without relying on operator skill. Furthermore, there is no need of operation and determination of an operator, so that complete automation and unmanned operation can be achieved.

### Embodiment 5

FIG. 10 is a configuration diagram of a major part including a supervisory control section of a desalination system according to Embodiment 5 of the present invention. The same components as those in Embodiment 1 are designated by the same numerals. In Embodiment 5, a plurality of semipermeable membrane elements 10 are arranged in series in one pressure vessel 12, and a pure-water permeation coefficient of a first-stage (first) semipermeable membrane element 76 is higher than a pure-water permeation coefficient of each of semipermeable membrane elements 10 in the second and subsequent stages. Embodiment 5 is different from Embodiment 1 in that, in the case of a configuration where a plurality of pressure vessels 12, which each accommodate a plurality of semipermeable membrane elements 10 in series, are connected in parallel to one another, a pure-water permeation coefficient of a first-stage (first) semipermeable membrane element 76 in a first pressure vessel 12 is higher than a pure-water permeation coefficient of a semipermeable membrane element 10 disposed in a first stage of a second pressure vessel 12. In FIG. 10, a pressure vessel 12, in which a semipermeable membrane element 76 having a high pure-water permeation coefficient is disposed in a first stage, is exclusively shown for convenience.

As with Embodiment 1, the upstream filtrate water 20 is separated from the downstream filtrate water 24 by the filtrate-water separation section 28. Pieces of information on quantity and quality of such filtrate water, i.e., the upstream filtrate-water-quantity information 46, the upstream filtrate-water-quality information 48, the downstream filtrate-water-quantity information 52, the downstream filtrate-water-quality information 54, and the feed-water pressure information 50 are provided to the index-value calculation section 40. The index value information 44 output from the index-value calculation section 40 to the display unit 42 is similar to that in Embodiment 1; hence, description thereof is omitted.

Bio-fouling is more easily accumulated with an increase in filtration flux. Specifically, an increase in filtration flux enhances concentration polarization on a membrane surface of the semipermeable membrane element 10, leading to an increase in amount of extraneous matters. Furthermore, microorganisms attached on the membrane surface more easily absorb nutrients in the feed water 14 in a high concentration because of the large amount of extraneous matters and the high concentration polarization, and consequently a larger amount of biofilms are formed. Hence, if the first-stage (first) semipermeable membrane element 76 located on a most upstream side of a first pressure vessel 12 has a larger pure-water permeation coefficient than a pure-water permeation coefficient of a semipermeable membrane element 10 disposed in a first stage of another pressure vessel 12, accumulation of bio-fouling on the semipermeable membrane element 76 having such a high pure-water permeation coefficient starts prior to accumulation of bio-fouling in a second pressure vessel.

As a result, formation of bio-fouling can be predicted before the formation is started within a pressure vessel including no semipermeable membrane element 76 having the high pure-water permeation coefficient. Specifically, start of formation of bio-fouling can be detected more early than ever. As described in Embodiment 1, some desalination system 15 may be configured such that only the first-stage (first) semipermeable membrane element 10 as shown in FIG. 3 is accommodated in a first pressure vessel 12, a plurality of semipermeable membrane elements 10 in the second and subsequent stages (second and later semipermeable membrane elements 10) are accommodated in a second pressure vessel 12 while being arranged in series, and such pressure vessels 12 are connected to each other with a valve therebetween. In such a case, a semipermeable membrane element 10 accommodated in a first pressure vessel 12 is formed of the semipermeable membrane element 76 having the high pure-water permeation coefficient, i.e., has a higher pure-water permeation coefficient than that of a semipermeable membrane element 10 disposed in a first stage of a second pressure vessel connected to the first pressure vessel 12 with a valve therebetween, thereby the accumulated amount of fouling can be more accurately determined.

### Embodiment 6

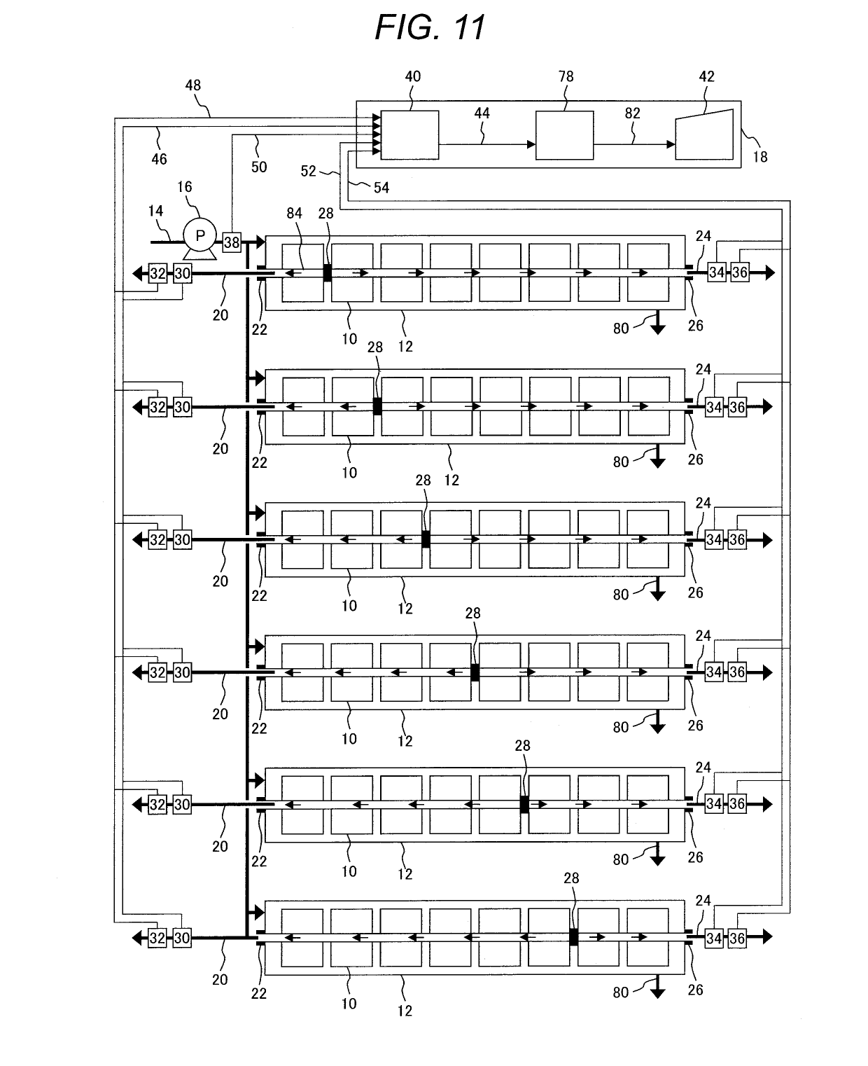

FIG. 11 is a configuration diagram of a major part including a supervisory control section of a desalination system according to Embodiment 6 of the present invention. The same components as those in Embodiment 1 are designated by the same numerals. Embodiment 6 is different from Embodiment 1 in that the major part is configured such that a plurality of pressure vessels 12, each of which accommodates a plurality of semipermeable membrane elements 10 in series, are connected in parallel to one another, and the filtrate-water separation sections 28 provided in the filtrate water pipes 84 within the individual pressure vessels 12 are disposed at positions different from one another. Moreover, Embodiment 6 is different from Embodiment 1 in that the supervisory controller 18 has a semipermeable-membrane-element state estimation section 78.

In view of one pressure vessel 12, as with Embodiment 1, the upstream filtrate water 20 is separated from the downstream filtrate water 24 by the filtrate-water separation section 28. Pieces of information on quantity and quality of such filtrate water, i.e., the upstream filtrate-water-quantity information 46, the upstream filtrate-water-quality information 48, the downstream filtrate-water-quantity information 52, the downstream filtrate-water-quality information 54, and the feed-water pressure information 50 are provided to the index-value calculation section 40.

FIG. 11 exemplarily illustrates a case where six pressure vessels 12, each of which accommodates eight semipermeable membrane elements 10 in series, are connected in parallel to one another. The semipermeable membrane elements 10 in the plurality of pressure vessels are assumed to be under the same conditions at the respective corresponding positions. In other words, the major part must be operated such that the first-stage (first) semipermeable membrane element 10 on an inflow side of the feed water 14 is in the same state in any of the pressure vessels 12. Similarly, the major part is operated such that the second-stage (second) semipermeable membrane element 10 is also in the same state in any of the pressure vessels 12. The same holds true for the semipermeable membrane elements 10 the third and subsequent stages (third and later).

In FIG. 11, the top pressure vessel 12 has the filtrate-water separation section 28 in the filtrate water pipe 84 portion between a first-stage (first) semipermeable membrane element 10 and a second-stage (second) semipermeable membrane element 10 on an inflow side of the feed water 14. The second top pressure vessel 12 has the filtrate-water separation section 28 in the filtrate water pipe 84 portion between a second stage and a third stage on an inflow side of the feed water 14. The filtrate-water separation section 28 is provided in the filtrate water pipe 84 portion between a third stage and a fourth stage in the third top pressure vessel 12, in the filtrate water pipe 84 portion between a fourth stage and a fifth stage in the fourth top pressure vessel 12, in the filtrate water pipe 84 portion between a fifth stage and a sixth stage in the fifth top pressure vessel 12, and in the filtrate water pipe 84 portion between a sixth stage and a seventh stage in the sixth top pressure vessel 12.

Operation of the semipermeable-membrane-element state estimation section 78 is now described.

The cake resistances of the semipermeable membrane elements 10 at the respective positions are denoted as R1, R2, . . . R8. The following two values are obtained from measurement data on the top pressure vessel 12 in FIG. 11.

(1) From measurement data of upstream filtrate water 20: R1

(2) From measurement data of downstream filtrate water 24: average (R1, R2, . . . R8)

where the function average ( ) is assumed to be subjected to simple averaging for items in the parenthesis.

The following two values are obtained from measurement data on the second top pressure vessel 12.

(1) From measurement data of upstream filtrate water 20: average (R1, R2)

(2) From measurement data of downstream filtrate water 24: average (R3, R4, . . . R8)

Similarly, the following two values are obtained from measurement data on the third top pressure vessel 12.

(1) From measurement data of upstream filtrate water 20:

average (R1, R2, R3)

(2) From measurement data of downstream filtrate water 24: average (R4, R5, . . . R8)

Similarly, the following are obtained from measurement data on the fourth top pressure vessel 12.

(1) From measurement data of upstream filtrate water 20: average (R1, R2, R3, R4)

(2) From measurement data of downstream filtrate water 24: average (R5, R6, . . . R8)

Similarly, the following are obtained from measurement data on the fifth top pressure vessel 12.

(1) From measurement data of upstream filtrate water 20: average (R1, R2, . . . R5)

(2) From measurement data of downstream filtrate water 24: average (R6, R7, R8)

Similarly, the following are obtained from measurement data on the sixth top pressure vessel 12.

(1) From measurement data of upstream filtrate water 20: average (R1, R2, . . . R6)

(2) From measurement data of downstream filtrate water 24: average (R7, R8)

The semipermeable-membrane-element state estimation section 78 solves these as simultaneous equations and thus obtains respective values (indexes 2) of R1, R2, . . . , and R8, and outputs the values as element state information to the display unit 42. Consequently, an operator can grasp a state of the semipermeable membrane element 10 disposed at each position.

When the state of each semipermeable membrane element 10 can be grasped, a situation of bio-fouling is clarified in more detail, and thus a chemical washing plan and a change plan of a semipermeable membrane element can be made more appropriately. In addition, knowing a situation of the semipermeable membrane element 10 disposed in a subsequent stage (on a downstream side) makes it possible to easily grasp degradation in performance of the semipermeable membrane element 10 not only due to bio-fouling but also due to scaling.

According to Embodiment 6, a state of each semipermeable membrane element is provided as element state information 82 to an operator by the display unit 42, thereby the operator can grasp detailed information on all the semipermeable membrane elements, and thus can continuously and effectively perform operation control of the desalination system without anxiety.

The invention further includes various modifications of the above-described Embodiments without limitation. For example, while the above-described Embodiments have been described in detail for ease in understanding of the invention, the invention is not necessarily limited to such Embodiments having all the described configurations. In addition, part of a configuration of an Embodiment may be replaced with a configuration of another Embodiment. Furthermore, a configuration of an Embodiment may be additionally provided with a configuration of another Embodiment. In addition, part of a configuration of each Embodiment may be additionally provided with a configuration of another Embodiment, omitted, or replaced with a configuration of another Embodiment.

### REFERENCE SIGNS LIST

1 raw water reservoir
2 microfiltration membrane
3 ultrafiltration membrane
4 coagulant tank
5 coagulant injection pump
6 wash reservoir
7 wash injection pump
8 energy recovery device
9 intermediate tank
10 semipermeable membrane element
11 flesh water reservoir
12 pressure vessel
13 concentrated water reservoir
14 feed water
15 desalination system
16 pressure pump
18 supervisory controller
20 upstream filtrate water
22 upstream filtrate-water intake port
24 downstream filtrate water
26 downstream filtrate-water intake port
28 filtrate-water separation section
30 upstream filtrate-water-quantity measuring section
32 upstream filtrate-water-quality measuring section
34 downstream filtrate-water-quantity measuring section
36 downstream filtrate-water-quality measuring section
38 feed-water pressure measuring section
40 index-value calculation section
42 display unit
44 index value information
46 upstream filtrate-water-quantity information
48 upstream filtrate-water-quality information
50 feed-water pressure information
52 downstream filtrate-water-quantity information
54 downstream filtrate-water-quality information
80 concentrated water
82 element state information
84 filtrate water pipe

What is claimed is:

1. A desalination system, comprising:
a plurality of semipermeable membrane elements accommodated in series in a pressure vessel;
a first intake port for intake of filtrate water from an upstream semipermeable membrane element in said pressure vessel;
a second intake port for intake of filtrate water from a downstream semipermeable membrane element in said pressure vessel; and
a supervisory controller that outputs an index correlated with fouling on said semipermeable membrane element based on at least one of first water quantity, first water quality, second water quantity, and second water quality, said first water quantity and said first water quality being quantity and quality of said filtrate water from said first intake port, and said second water quantity and said second water quality being quantity and quality of said filtrate water from said second intake port.

2. A desalination system having a semipermeable membrane element accommodated in a pressure vessel, and a filtrate water pipe for catchment of said filtrate water provided in said semipermeable membrane element, comprising:
a filtrate-water separation section provided in said filtrate water pipe, for taking filtrate water on an upstream side of said filtrate-water separation section and filtrate water on a downstream side of said filtrate-water separation section separately; and
a supervisory controller for outputting an index correlated with fouling on said semipermeable membrane element based on at least one of first water quantity, first water quality, second water quantity, and second water quality, said first water quantity and said first water quality being quantity and quality of said upstream filtrate water, and said second water quantity and said second water quality being quantity and quality of said downstream filtrate water.

3. The desalination system according to claim 1 or 2,
wherein said supervisory controller includes a display section, and allows said display section to display on a screen said index correlated with fouling on said semipermeable membrane element.

4. The desalination system according to claim 1 or 2,
wherein said supervisory controller includes a display section and a threshold input section, and compares a threshold received from said threshold input section to said index correlated with fouling on said semipermeable membrane element, and allows said display section to display alarm information based on a comparison result.

5. The desalination system according to claim 1 or 2, further comprising:
a wash reservoir for reserving a wash for washing of the pressure vessel; and
a wash injection pump for feeding said wash to said pressure vessel,
wherein said supervisory controller includes a display section, and allows said display section to display chemical washing time of said pressure vessel on a screen based on said index correlated with fouling on said semipermeable membrane element.

6. The desalination system according to claim 1 or 2, further comprising:
a pretreatment section configured of at least a reservoir reserving water to be treated to be fed to said pressure vessel, a coagulant tank reserving one of a polymeric coagulant and an inorganic coagulant, and a coagulant injection pump that injects a predetermined amount of one of said polymeric coagulant and said inorganic coagulant into said reservoir,
wherein said supervisory controller controls said coagulant injection pump based on said index correlated with fouling on said semipermeable membrane element.

7. The desalination system according to claim 1,
wherein a plurality of said pressure vessels are connected in parallel to one another,
among a plurality of semipermeable membrane elements accommodated in a first pressure vessel, a first-stage semipermeable membrane element that receives inflow of feed water has a higher pure-water permeation coefficient than a pure-water permeation coefficient of each of said semipermeable membrane elements disposed in second and subsequent stages,
said pure-water permeation coefficient of said semipermeable membrane element disposed in said first stage of said first pressure vessel is higher than a pure-water permeation coefficient of each of semipermeable membrane elements disposed in first stages of other pressure vessels, and
said supervisory controller outputs said index correlated with fouling on said semipermeable membrane element based on at least one of first water quantity, first water quality, second water quantity, and second water quality, said first water quantity and said first water quality being quantity and quality of filtrate water from said semipermeable membrane element disposed in said first stage of said first pressure vessel, and said second water quantity and said second water quality being quantity and quality of filtrate water from said semipermeable membrane element disposed in each of said second and subsequent stages.

8. The desalination system according to claim 1,
wherein a plurality of said pressure vessels are connected in parallel to one another,
each of said pressure vessels includes a filtrate water pipe for catchment of filtrate water, said filtrate water pipe being disposed penetrating through said a plurality of semipermeable membrane elements accommodated in series in said pressure vessel, and a filtrate-water separation section for separation of upstream filtrate water and downstream filtrate water from each other, said filtrate-water separation section being provided in one place of the filtrate water pipe, and
said filtrate-water separation section is provided between two different semipermeable membrane elements in each of said pressure vessels.

9. The desalination system according to any one of claims 1, 2, 7, and 8,
wherein said supervisory controller outputs, as said index, one of temporal variation of quantity of said upstream filtrate water and temporal variation of quantity of said downstream filtrate water.

10. The desalination system according to any one of claims 1, 2, 7, and 8,
wherein said supervisory controller outputs, as said index, a cake resistance obtained based on pressure of feed water flowing into said pressure vessel, and quantity and quality of said upstream filtrate water.

11. The desalination system according to any one of claims 1, 2, 7, and 8,
wherein said supervisory controller outputs, as said index, a ratio of quantity of said upstream filtrate water to quantity of said downstream filtrate water.

12. The desalination system according to any one of claims 1, 2, 7, and 8,
wherein said supervisory controller outputs, as said index, pH as a type of quality of said upstream filtrate water.

13. The desalination system according to claim 2 or 8,
wherein said filtrate-water separation section is one of a sealing plug, a member having a shutter mechanism, and a cylindrical or spherical member receivable in said filtrate water pipe, and is configured to hydraulically separate filtrate water circulating within said filtrate water pipe.
